(19) United States
(12) Patent Application Publication
(10) Pub. No.: US 2010/0300256 A1
(43) Pub. Date: Dec. 2, 2010

(54) MACHINE TOOL SAFETY DEVICE

(76) Inventors: Andreas Loewe, Lahstedt (DE); Ingo Herrmann, Friolzheim (DE); Klaus Marx, Stuttgart (DE); Wolfgang Niehsen, Bad Salzdetfurth (DE); Thilo Koeder, Gerlingen (DE); Georg Stellmann, Ludwigsburg (DE); Joachim Platzer, Remseck-Hochberg (DE); Sebastian Jackisch, Ludwigsburg (DE)

Correspondence Address: KENYON & KENYON LLP, ONE BROADWAY, NEW YORK, NY, 10004, US

(21) Appl. No.: 12/733,766

(22) PCT Filed: Jul. 22, 2008
(86) PCT No.: PCT/EP2008/059553

§ 371 Date: Aug. 16, 2010

(30) Foreign Application Priority Data
Sep. 20, 2007 (DE) 102007044804.1

(51) Int. Cl. B26D 5/00

(52) U.S. Cl. 83/72

(57) ABSTRACT

A machine tool safety device has a recognition unit which is provided for recognizing an application situation for a machine tool. The recognition unit includes an imaging unit for monitoring a first safety range, and a sensor unit, which is different from the imaging unit, for monitoring a second safety range.

### BACKGROUND OF THE INVENTION

1. Field of the Invention

The present invention is directed to a machine tool safety device.

2. Description of Related Art

A recognition unit for recognizing an application situation for a machine tool is known.

### BRIEF SUMMARY OF THE INVENTION

The present invention is directed to a machine tool safety device having a recognition unit provided for recognizing an application situation for a machine tool.

It is proposed that the recognition unit includes an imaging unit for monitoring a first safety range, and a sensor unit, which is different from the imaging unit, for monitoring a second safety range. This allows particularly high reliability to be achieved in recognizing an application situation for a machine tool, in particular in recognizing the presence of a human body part in a safety range. An “imaging unit” refers in particular to a unit which is provided for recording images which are suited in particular for evaluation with the aid of an image processing program. The imaging unit is advantageously operatively linked to an image processor which is provided for processing images recorded by the imaging unit. For example, the imaging unit is designed as a video camera. The imaging unit is particularly advantageously provided for recording images in the visible range. The sensor unit and the imaging unit preferably have a different detection frequency or image frequency (or frame rate). It is particularly advantageous for the sensor unit to have a higher detection frequency than the imaging unit.

In one preferred specific embodiment of the present invention it is proposed that the sensor unit has at least one sensitivity range for detecting radiation in the infrared range, thus allowing a high detection frequency of the sensor unit, and therefore a short response time, for a recognition operation to be achieved. It is proposed in particular that the sensitivity range is provided for detecting radiation in a thermal infrared range. In the present context, “thermal” infrared range refers in particular to a wavelength interval of the infrared spectrum which is greater than a wavelength of 8 μm and preferably less than a wavelength of 15 μm. In particular, the thermal infrared range is in the IR-C range. The recognition unit is advantageously tailored for recognition on the basis of a temperature parameter-based differentiation between types of materials. In particular, the sensor unit is tailored for the recognition of human tissue in the second safety range via the selection of the sensitivity range.

The first safety range and the second safety range may have an identical design. However, it is advantageous when the imaging unit and the sensor unit are provided for monitoring different safety ranges. For example, the safety ranges may be separate or may adjoin one another. An advantageous interaction of the imaging unit and the sensor unit in recognizing an application situation may be achieved when the safety ranges overlap. In particular, a particularly effective complementarity may be achieved when the first safety range encompasses the second safety range.

It is further proposed that the second safety range corresponds to a tool range, thus allowing a high level of safety to be achieved. In this respect it is particularly advantageous when the sensor unit has a higher detection frequency than the imaging unit, thus allowing a particularly short response time to be achieved in recognizing a type of material in the tool range. In the present context, a “tool range” refers in particular to a range which is composed of points having a minimum distance of 10 cm maximum, advantageously 5 cm maximum, and preferably 2 cm maximum, from a tool and/or a tool extension range of the machine tool. A “tool extension range” is composed in particular of points which may potentially be occupied by a tool, for example due to a movable support of a tool support unit for supporting the tool relative to a machine tool work surface, for example for a compound miter saw, miter saw, crosscut saw, etc. The imaging unit has a field of vision which during operation advantageously establishes a monitored range of the machine tool. The monitored range preferably includes at least one partial range of the tool range. The vertical projection of the monitored range on the work surface advantageously includes the vertical projection of the tool range on the work surface. The monitored range may also include at least one partial range of the tool extension range.

Particularly rapid recognition may be achieved when the recognition unit has an evaluation unit which is provided for evaluating at least one feature from the group composed of color, contour, and texture on the basis of image data recorded by the imaging unit. It is particularly advantageous to provide the evaluation unit for detecting an application situation by comparing image data to previously stored data of sample images.

It is further proposed that the recognition unit has an evaluation unit which is provided for ascertaining a path of motion of an object moving in a safety range. In this manner high speed may be achieved in recognizing a hazard potential during operation of the machine tool. It is particularly advantageous when the evaluation unit is provided for extrapolating the path of motion to a future position of the object relative to the tool. The path of motion is preferably ascertained on the basis of image data which are recorded by the imaging unit.

In one advantageous refinement of the present invention, it is proposed that the recognition unit has an evaluation unit which is provided for ascertaining a rate of speed of an object moving in a safety range. In this regard, great flexibility in the use of the machine tool may be achieved when the tool operation monitoring device has at least two safety modes, each being assigned to a particular rate of speed. The rate of speed is preferably ascertained on the basis of image data which are recorded by the imaging unit.

In one example embodiment of the present invention, it is proposed that the machine tool safety device has a control unit, which requires a recognition operation of the imaging unit and a recognition operation of the sensor unit for triggering an actuator unit for carrying out a safety measure. In this manner high reliability may be achieved, and mistriggering of the actuator unit may advantageously be avoided. In this regard, the control unit requires in particular that a recognition signal produced with the aid of the imaging unit be generated and that a recognition signal produced with the aid of the sensor unit be generated, each at a point in time before the actuator unit is triggered.

It is further proposed that the machine tool safety device has a control unit which in at least one operating mode is provided for triggering an actuator unit for carrying out a safety measure as a function of a recognition signal which is triggered by the sensor unit, thus allowing rapid recognition to be achieved. The imaging unit may be associated with a warning mode of the machine tool safety device.

In this regard, a high level of safety and ease of use are achieved when the machine tool safety device includes means which in a blocking mode of the control unit is provided for blocking the triggering of the actuator unit. “The triggering of the actuator unit” refers in particular to triggering on the basis of a recognition signal generated by the sensor unit, it being possible to trigger the actuator unit on the basis of a recognition signal generated by the imaging unit.

It is further proposed that in an enabling mode of the control unit the means is provided for canceling the blocking as a function of a recognition signal which is triggered by the imaging unit, thus allowing advantageous complementarity of the sensor unit and the imaging unit to be achieved. In particular, the blocking mode may be canceled on the basis of an ascertained path of motion of an object in the first safety range.

In a further example embodiment of the present invention it is proposed that the machine tool safety device includes a control unit which has a calibration mode for calibrating the recognition unit, thus allowing the precision and reliability of a recognition operation of the recognition unit to be increased.

### BRIEF DESCRIPTION OF THE SEVERAL VIEWS OF THE DRAWING

FIG. 1 shows a side view of a circular table saw having a recognition unit.

FIG. 2 shows the circular table saw in a top view, together with two safety ranges of the recognition unit.

FIG. 3 shows a schematic view of the recognition unit and actuator units.

FIG. 4 shows the ascertainment of the path of motion of a hand in a first safety range.

FIG. 5 shows the recognition of the hand in a tool range.

### DETAILED DESCRIPTION OF THE INVENTION

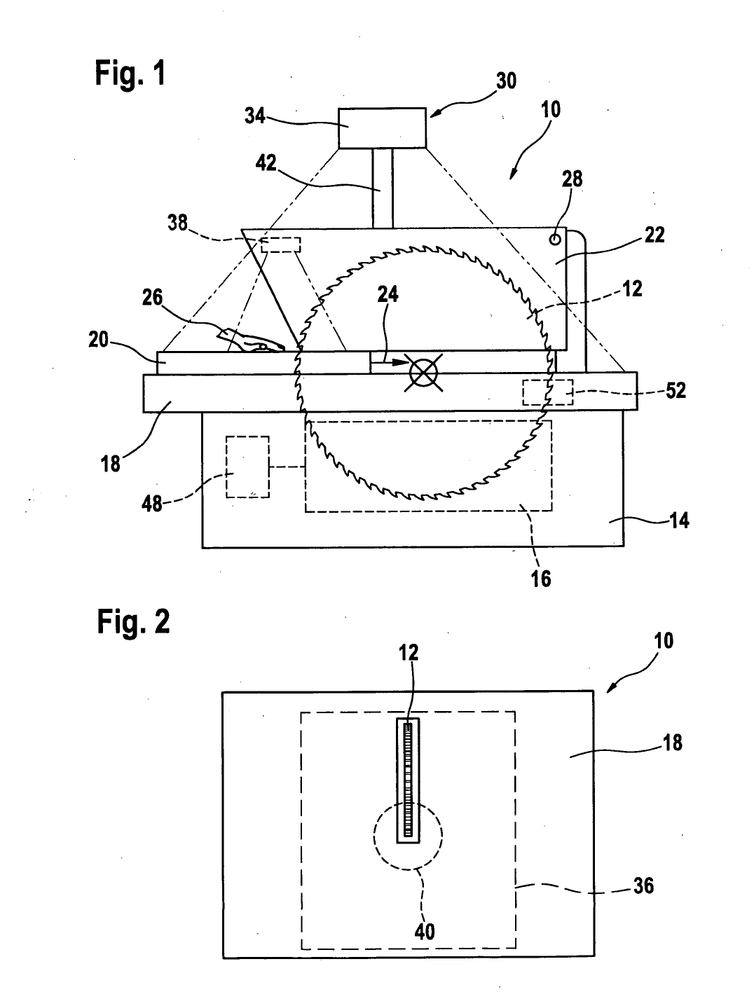

FIG. 1 shows a machine tool 10 designed as a stationary device, in particular as a circular table saw, in a side view. Machine tool 10 has a tool 12 which is designed as a disk-shaped saw blade, and which in operation of the saw is rotationally driven with the aid of a drive unit 16 situated in a drive housing 14 and designed as an electric motor. Supported on drive housing 14 is a workbench 18 on which a workpiece 20 to be machined may be placed. To protect an operator, machine tool 10 includes a protective device 22 designed as a protective device for covering tool 12, the protective device covering a cutting edge of tool 12 over a portion of the circumference of the cutting edge. In a nonoperating state of machine tool 10, the protective device covers the portion of tool 12 which projects beyond workbench 18. For machining workpiece 20, the workpiece is moved by an operator in a known manner in a working direction 24 in the direction of tool 12, using one hand 26 schematically illustrated in the figure. This causes protective device 22, which is rotatably supported about a rotational axis 28, to be swiveled upward by workpiece 20, thereby exposing the tool cutting edge.

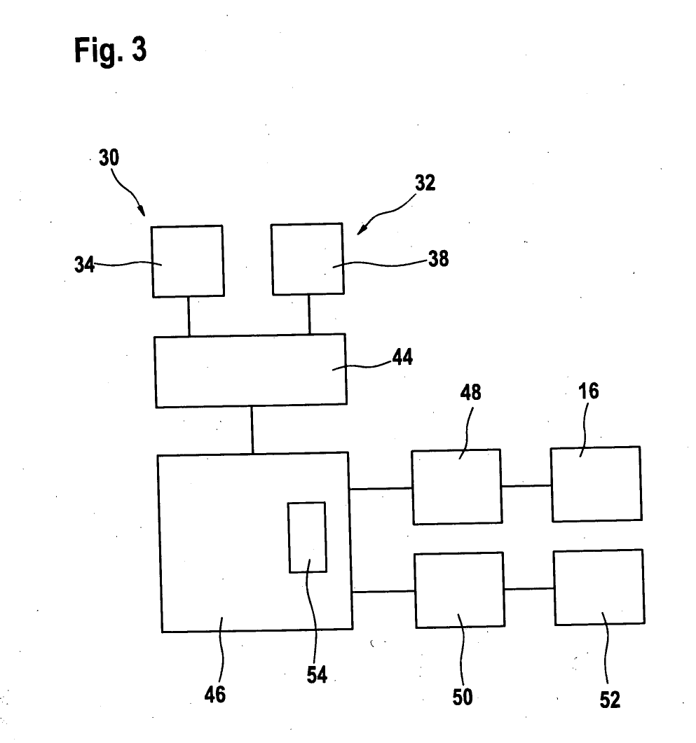

To increase operator safety, machine tool 10 is provided with a machine tool safety device 30. Machine tool safety device 30 has a recognition unit 32, shown in FIG. 3, which is provided for recognizing a hazard situation during use of machine tool 10. For this purpose, recognition unit 32 has an imaging unit 34 which is designed as a video camera and is used for monitoring a first safety range 36. Safety range 36 is shown in FIG. 2, which illustrates machine tool 10 in a top view. The illustration of protective device 22 has been omitted, in FIG. 2 for the sake of clarity. In addition to imaging unit 34, recognition unit 32 also has a sensor unit 38 which is provided for monitoring a second safety range 40.

As shown in FIG. 2, safety ranges 36, 40 have different designs. Second safety range 40 corresponds to a tool range. The second safety range is composed of points which have a minimum distance of 2 cm maximum from tool 12. In particular, the monitored tool range is composed of points having a minimum distance of 2 cm maximum from the front edge region of tool 12. The front edge region of tool 12 corresponds to the region in which workpiece 20 contacts the rotating edge of tool 12. In the exemplary embodiment under discussion, safety range 40 is circular. This safety range has a midpoint in the edge region of tool 12 and a radius of 2 cm. The design of the monitored safety range 40 is specified by sensor unit 38, in particular by a lens unit (not illustrated in detail) of sensor unit 38, and may have other shapes considered practical by one skilled in the art. First safety range 36 is larger than second safety range 40, and encompasses second safety range 40. The contour of first safety range 36 on workbench 18 includes in particular at least 25%, advantageously at least 50%, of the entire workbench surface.

Imaging unit 34 is affixed above workbench 18, in particular above tool 12, with the aid of a support device 42 designed as a fastening arm, it being possible for support device 42 to be fastened to workbench 18 and/or to drive housing 14. Sensor unit 38 is mounted in protective device 22, preferably in a partial range of protective device 22 situated above the edge region of tool 12. Imaging unit 34 may also be situated in protective device 22. Imaging unit 34 may be provided with a wide-angle lens for achieving a wide field of vision. Imaging unit 34 and/or sensor unit 38 may be situated laterally to tool 12, such as on a workpiece stop, for example.

The operating principle of machine tool safety device 30 is described with reference to FIG. 3. The figure shows recognition unit 32, which includes imaging unit 34, sensor unit 38, and an evaluation unit 44, in a schematic view. The recognition unit is provided for evaluating data recorded by imaging unit 34 or sensor unit 38. Evaluation unit 44 may be a single evaluation means associated with imaging unit 34 and sensor unit 38, or may have a first evaluation means for imaging unit 34 and an evaluation means, different from the first evaluation means, for sensor unit 38. Evaluation unit 44 has, for example, at least one microprocessor, and may have a memory unit for an evaluation program and/or for evaluation data, for example. Machine tool safety device 30 also has a control unit 46 which is operatively linked to evaluation unit 44 and to actuator units 48, 50. Actuator unit 48, which is operatively linked to drive unit 16, is provided for modifying a drive of tool 12 as a function of a trigger signal of control unit 46. In particular, with the aid of actuator unit 48 the rotational speed of tool 12 may be reduced, or the tool drive may be completely stopped. Machine tool safety device 30 also has a further actuator unit 50 which is operatively linked to control unit 46 and is provided for actuating safety means 52 as a function of a trigger signal of control unit 46. This safety means 52, likewise shown in FIG. 1, is provided as a braking device which is designed, for example, as a brake disk or brake drum, and is used for braking the rotating tool 12. Safety means 52 may brake tool 12 by establishing direct contact with tool 12 and/or with a drive shaft for driving tool 12. Machine tool safety device 30 may have a further safety means, which may be actuated by actuator unit 50. For example, a safety means may be provided which removes tool 12 from the working range of machine tool 10 as needed, for example when tool 12 moves down into drive housing 14. Alternatively or additionally, actuator unit 50 may actuate a safety means, which as needed triggers a motion of protective device 22 to block access to the edge region of tool 12.

As described above, imaging unit 34 is designed as a video camera which is provided in particular for recording images in the visible frequency range. Imaging unit 34 may be designed as an infrared camera. This infrared camera may be provided for detecting images in one or more of the IR-A, IR-B and/or IR-C ranges. In addition to detection in the infrared range, the infrared camera may be provided for detecting images in the visible range. Evaluation unit 44 is used to evaluate a color feature, contour feature, and/or texture feature of an object present in first safety range 36 on the basis of image data recorded by imaging unit 34. Evaluation unit 44 is provided in particular for recognizing the presence of a human body part in safety range 36 on the basis of one or more of these features. Evaluation unit 44 examines in a targeted manner the image data continuously recorded by imaging unit 34 for a texture which is typical of human tissue and/or of a typical article of clothing worn by an operator, a protective glove, for example. The recognition operation may be carried out, for example, by comparing recorded image data to sample pattern data stored in a memory unit.

Control unit 46 is also provided with a calibration mode. The calibration mode is stored, for example, in the form of a program in a memory unit (not illustrated in detail) associated with control unit 46. In carrying out the calibration mode, prior to actuating the tool, recognition unit 32 is calibrated by the end user of machine tool 10 holding one hand in the field of vision of imaging unit 34 and/or of sensor unit 38, and features of the hand being analyzed by evaluation unit 44 and stored in a memory unit. In this manner the light conditions and the coloring of the hand may be taken into account in a subsequent recognition operation.

If an evaluation operation of evaluation unit 44 results in recognition, i.e., a recognition operation is present, a recognition signal is sent to control unit 46. The resolution of imaging unit 34 is selected in such a way that a feature of the recorded image data may be evaluated with great accuracy. For example, imaging unit 34 may have a resolution of at least 64×64 pixels.

Sensor unit 38 preferably has a shorter detection time than imaging unit 34 for sampling associated safety range 40. As a video camera, imaging unit 34 typically has an image frequency corresponding to a given detection time. A sensor unit 38 is selected which has a lower resolution than imaging unit 34. For example, sensor unit 38 has a resolution which is typically less than the resolution of imaging unit 34 by two orders of magnitude. In this manner, with the aid of sensor unit 38 a shorter recognition operation may be achieved in recognizing the presence of a human body part in corresponding safety range 40. To achieve a particularly short recognition time, sensor unit 38 is designed as an infrared sensor. Such a sensor system has a typical image frequency which is greater than the image frequency of imaging unit 34 and which thus corresponds to a shorter detection time. Sensor unit 38 preferably has a sensitivity range which is suitable for detecting radiation in the thermal infrared range. In particular, the sensitivity range for detecting black body radiation is provided in a wavelength interval which corresponds to a typical temperature of a human body part. In the example under discussion, sensor unit 38 is designed as a thermopile. Sensor unit 38 may also be designed as a pyroelectric sensor or bolometer sensor. If an evaluation operation by evaluation unit results in a recognition 44 on the basis of temperature parameters detected by sensor unit 38, evaluation unit 44 sends a recognition signal to control unit 46.

Control unit 46 is used to trigger one or more actuator units 48, 50 as a function of a signal of evaluation unit 44. The control unit transmits a trigger signal to corresponding actuator unit 48 or 50. Control unit 46 preferably has at least one microprocessor, and may also have a memory unit for storing data, for example for storing a program used for carrying out control operations. For triggering one of actuator units 48, 50, control unit 46 requires a recognition operation of imaging unit 34 and a recognition operation of sensor unit 38. If a recognition operation is present which has been carried out by imaging unit 34, i.e., a recognition signal triggered by imaging unit 34 is sent to control unit 46, then following this operation an actuator unit 48 or 50 may be triggered by control unit 46 on the basis of a recognition signal triggered by sensor unit 38. If a recognition signal is sent to control unit 46 as the result of a recognition operation of sensor unit 38 without a recognition signal having been triggered beforehand by imaging unit 34, control unit 46 does not cause triggering of an actuator unit 48 or 50. For this purpose, control unit 46 is provided with control means 54. This control means is provided for blocking, in a blocking mode of control unit 46, the triggering of an actuator unit 48 or 50 for a recognition signal generated by sensor unit 38. Control unit 46 automatically carries out the blocking mode upon start-up of machine tool safety device 30. If a recognition signal triggered by sensor unit 38 is sent to control unit 46, this recognition signal is not converted to a trigger signal for triggering an actuator unit 48 or 50. It is possible to trigger an actuator unit 48 or 50 in blocking mode on the basis of a recognition signal generated by imaging unit 34. If a recognition signal triggered by imaging unit 34 is sent to control unit 46, control unit 46 carries out an enabling mode in which control means 54 cancels the blocking. In this enabling mode a recognition signal triggered by sensor unit 38 may be converted by control unit 46 to a trigger signal for triggering an actuator unit 48 or 50.

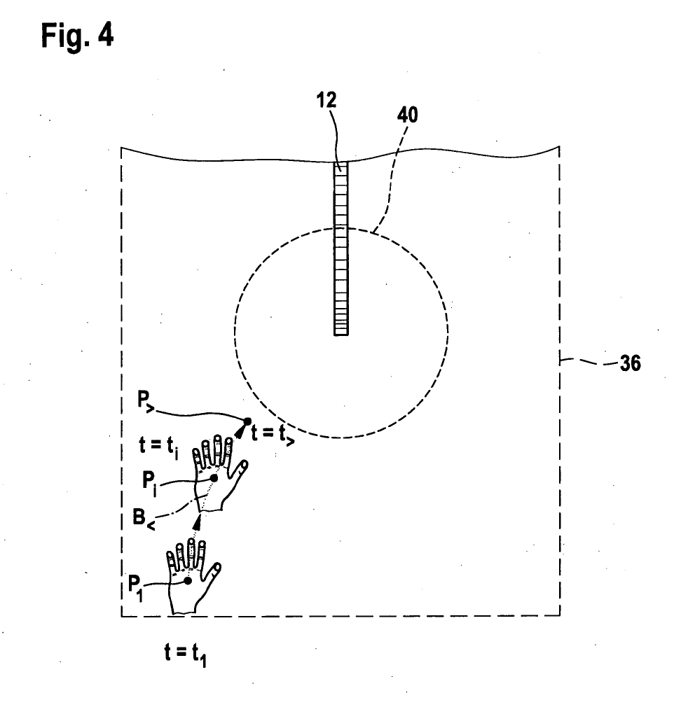

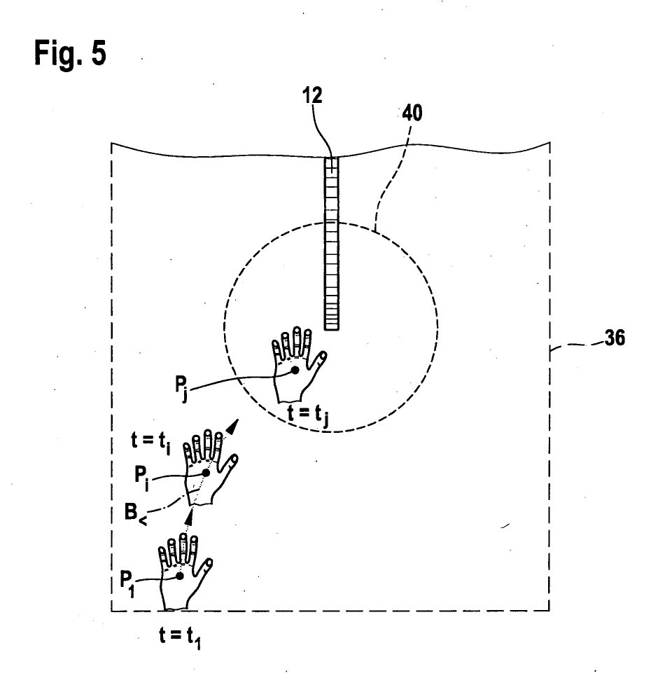

Recognition operations with the aid of imaging unit 34 and sensor unit 38 are explained in greater detail with reference to FIGS. 4 and 5. FIGS. 4 and 5 show a partial range of workbench 18 in which the contours of safety ranges 36, 40 to be monitored are illustrated by dashed lines, and a partial range of tool 12 is illustrated in a top view. After recognizing the presence of a human body part in safety range 36, in particular a hand of an operator, position P₁ of the hand at a point in time t₁ relative to safety range 40 is ascertained. Imaging unit 34 continuously detects images of safety range 36 at successive points in time. The image data are evaluated in real time by continuously evaluating the detected sequence with the aid of evaluation unit 44. In this regard, the recorded images may be consecutively evaluated. In the example considered in FIG. 4, the hand of the operator is located in a position Pᵢ at a later point in time tᵢ. A sequence of images (not illustrated in the figure for the sake of clarity) may be recorded between points in time t₁ and tᵢ. By ascertaining the various positions of the hand of an operator between P₁ and Pᵢ, evaluation unit 44 ascertains path of motion B_{<} of the hand of the operator. On the basis of this path of motion B_{<}, which has been traversed by the hand of the operator before the instantaneous detection point in time tᵢ, evaluation unit 44 determines an expected position P_{>} for the hand of the operator at a later point in time t_{>}. Path of motion B_{<}, ascertained on the basis of recorded images is extrapolated to future position P_{>} with the aid of evaluation unit 44. If evaluation unit 44 identifies path of motion B_{<} or an extrapolated path of motion as a path of motion leading to safety range 40, evaluation unit 44 transmits a recognition signal to control unit 46. The control unit brings about the transition from blocking mode to enabling mode. In one safety mode, control unit 46 is provided for triggering an optical and/or acoustic signal for warning the operator on the basis of this recognition signal triggered by imaging unit 34. Evaluation unit 44 is also provided for ascertaining a rate of speed of the detected hand of an operator in safety range 36 on the basis of images recorded at different points in time. Evaluation unit 44 determines a rate of speed on the basis of a comparison of positions P₁ and Pᵢ ascertained at the two points in time t₁ and tᵢ. For example, a hand motion may be associated with a speed level “fast,” “moderately fast,” “slow,” etc. If a hand motion is identified as a “fast” motion, evaluation unit 44 triggers a recognition signal, on the basis of which control unit 46 actuates triggering of an actuator unit 48 or 50. If a motion is recognized as a “moderately fast” or “slow” motion which leads to safety range 40, evaluation unit 44 triggers a recognition signal, on the basis of which the above-described enabling mode is switched on and the operator is warned.

FIG. 5 shows the system shown in FIG. 4 at a point in time tⱼ>tᵢ. The hand of the operator is situated at a position Pⱼ in safety range 40. Sensor unit 38 recognizes the temperature signature of the hand by detecting the black body radiation from the hand, and after a brief recognition time a recognition signal is transmitted to control unit 46. As described above, control unit 46 is in its enabling mode as the result of ascertained path of motion B_{<}, and control unit 46 converts the recognition signal to a trigger signal for triggering an actuator unit 48 or 50. For example, the rotary drive of tool 12 is stopped, or tool 12 is moved into drive housing 14 as the result of actuating a spring retention device. In a further safety mode it is possible for evaluation unit 44 to ascertain a path of motion of the hand in safety range 40 on the basis of parameters detected by sensor unit 38, and to trigger a recognition signal as a function of the course of the ascertained path of motion.

Machine tool safety device 30 according to the present invention is suited for other machine tools in which recognition of a human body part is advantageous, such as for compound miter saws, crosscut saws, miter saws, routers, etc.

1-14. (canceled)

15. A machine tool safety device, comprising:
a recognition unit configured to recognize an application situation for a machine tool, wherein the recognition unit includes an imaging unit configured to monitor a first safety range, and a sensor unit configured to monitor a second safety range, wherein the imaging unit and the sensor unit are different.

16. The machine tool safety device as recited in claim 15, wherein the sensor unit has at least one sensitivity range for detecting a radiation in the infrared range.

17. The machine tool safety device as recited in claim 16, wherein the at least one sensitivity range is provided for detecting a radiation in the thermal infrared range.

18. The machine tool safety device as recited in claim 16, wherein the first safety range encompasses the second safety range.

19. The machine tool safety device as recited in claim 15, wherein the second safety range corresponds to a tool range.

20. The machine tool safety device as recited in claim 15, wherein the recognition unit includes an evaluation unit configured to evaluate, on the basis of image data recorded by the imaging unit, at least one of color, contour, and texture.

21. The machine tool safety device as recited in claim 15, wherein the recognition unit includes an evaluation unit configured to ascertain a path of motion of an object moving in a safety range.

22. The machine tool safety device as recited in claim 15, wherein the recognition unit includes an evaluation unit configured to ascertain a speed of an object moving in a safety range.

23. The machine tool safety device as recited in claim 15, further comprising:
a control unit configured to selectively trigger an actuator unit to perform a safety measure, wherein the control unit selectively triggers the actuator unit based on outputs of the imaging unit and the sensor unit.

24. The machine tool safety device as recited in claim 15, further comprising:
a control unit configured to selectively trigger an actuator unit to perform a safety measure in at least one operating mode, wherein the control unit selectively triggers the actuator unit based on a first recognition signal generated by the sensor unit.

25. The machine tool safety device as recited in claim 24, wherein the control unit includes a blocking unit configured to selectively block, in a blocking mode, the triggering of the actuator unit.

26. The machine tool safety device as recited in claim 25, wherein the blocking unit is configured to disable the blocking, in an enabling mode, as a function of a second recognition signal generated by the imaging unit.

27. The machine tool safety device as recited in claim 25, wherein the control unit has a calibration mode for calibrating the recognition unit.
